(19) United States
(12) Patent Application Publication
(10) Pub. No.: US 2010/0217498 A1
(43) Pub. Date: Aug. 26, 2010

(54) ENGINE CONTROL METHOD BASED ON GRAPHIC SIGNATURES

(76) Inventors: Bilal Youssef, Villeurbanne (FR); Gilles Corde, Bois-Colombes (FR)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/680,745

(22) PCT Filed: Oct. 24, 2008
(86) PCT No.: PCT/FR08/01507

§ 371 Date: Mar. 30, 2010

(30) Foreign Application Priority Data
Oct. 30, 2007 (FR) 07/07702

(51) Int. Cl. G06G 7/70

(52) U.S. Cl. 701/101

(57) ABSTRACT

A method of extracting useful information for control of an internal-combustion engine, based on graphic signatures is disclosed. A signal carrying at least information relative to engine operation is acquired. This signal is then converted, for each engine cycle, to a graphic signature translating a set of characteristic features of the signal in a form of a graph which is simple to analyze. At least one attribute of this signature is then determined, from which the pertinent information is estimated by a predetermined relation between the attribute and the information. Finally, the information is used to control the engine

### BACKGROUND OF THE INVENTION

### Field of the Invention

The present invention relates to the sphere of internal-combustion engine control. More particularly, the invention relates to a method allowing to analyze signals obtained from detectors positioned on the engine, so as to extract pertinent information for engine control.

Internal-combustion engines are becoming more and more complex, and their controls increasingly sophisticated. Advanced engine control and diagnosis systems require detailed information concerning the various events that occur within the engine (injections, combustion, . . . ). Monitoring of these events and knowledge of the engine parameters depending thereon allow to considerably improve engine performances and emissions reduction.

There are various known methods of acquiring pertinent information for engine control.

The following in-cylinder pressure reconstruction methods are for example known:

J. Antoni, J. Daniére, F. Guillet. <<Effective Vibration Analysis of IC Engines using Cyclostationarity. Part I: A Methodology for Condition Monitoring<<, Journal of Sound and Vibration. Vol. 257, No. 5, November 2002, pp. 815-837.

J. Antoni, J. Daniére, F. Guillet, R. B. Randall. <<Effective Vibration Analysis of IC Engines using Cyclostationarity. Part II: New Results on the Reconstruction of the Cylinder Pressure<<, Journal of Sound and Vibration. Vol. 257, No. 5, November 2002, pp. 839-856.

Combustion parameter estimation methods are also known:

J., Chauvin, Y., Bentolila and O., Grondin (2006). Méthode D'estimation de Paramétres de Combustion á Partir de Signauz Vibratoires. Brevet 06/02 111. Institut Francais du pétrole.

Rapid-Prototyping Multi-Sensors Processing Platform for Real Time Engine Control and Diagnosis, Olivier Grondin, Laurent Duval, Fabrice Guillemin, Stephan Ker, Gilles Corde, Christian Vigild. Fifth IFAC Symposium on Advances in Automotive Control Seascape Resort, Aptos, California, USA. August 2007.

A difficulty inherent in all these methods is linked with the complexity of the signal that carries a large amount of information. Some is directly linked with the engine operation, some indirectly, and finally some of this information is made up of perturbations, noise or a background signal.

The acquisition of pertinent information for engine control thus involves analysis of a complex signal in order to extract useful information, that is linked with the engine operation, from among a large amount of other “parasitic” information.

Considering that engine control requires real-time applications, this analysis technique has to be simple, fast and accurate.

### SUMMARY OF THE INVENTION

The invention is a method for extracting useful information for control of an internal-combustion engine. This method is based on graphic signatures generated from high-frequency signals obtained from various engine detectors.

The invention relates to a method for control of an internal-combustion engine comprising at least one detector, from which at least one signal containing at least one piece of information relative to the operation of the engine is acquired. The method comprises the following steps:

selecting a function allowing a signal to be converted into a graphic signature; and, for each engine cycle;
converting the signal into the graphic signature by use of the function;
extracting the information from the signature; and
using the information to control the engine.

The information can be extracted by carrying out the following steps: selecting at least one attribute of the signature;

determining a relation between this attribute and the information; and, for each engine cycle;
calculating an attribute value for the signature; and
extracting the information with the value and of the relation.

When the signal is a set of discrete measurements, the graphic signature can be obtained by a function providing projection of signal measurements contained in a sliding time window, from a multidimensional space to a space of smaller dimension, for example of two dimensions. The following steps can therefore be carried out at any time t:

constructing a vector Yₘ(t) having a measurement at time t, y(t), and of N measurements preceding time t; and
converting vector Yₘ(t) to a pair (y₁, y₂) representing a point in a two-dimensional plane.

The relation between the attribute and the information can be obtained from the following method, carried out on the engine test bench:

constructing a graphic signature for different information values; a, calculating the attribute for each signature; and
deducing a relation by comparing the attribute/information pairs for each signature.

According to an embodiment, the signal is a pressure measurement in a common rail of the engine. The information to be extracted can be the detection of an injection. In this case, it is possible to use as the attribute the surface area of the signature. Then detection of an injection is determined by comparing the surface area of the signature with a predetermined threshold.

According to another embodiment, the signal is an instantaneous engine speed measurement. The information to be extracted can be an estimation of the engine torque. In this case, it is possible to use an attribute based on a horizontal diameter and a vertical diameter of the graphic signature.

### BRIEF DESCRIPTION OF THE DRAWINGS

Other features and advantages of the method according to the invention will be clear from reading the description hereafter of embodiments given by way of non limitative examples, with reference to the accompanying figures wherein:

FIG. 1 illustrates the steps of the method of extracting engine information from high frequency measurements using graphic signatures;

FIG. 2 illustrates the graphic signature construction method according to the invention;

FIG. 3 shows an example of definition of intermediate points during the construction of a graphic signature;

FIG. 4 is an example of signatures obtained from the real measurements of the pressure in the rail, in the case of two injections;

FIG. 5 is an example of signatures obtained from the real measurements of the instantaneous engine speed for different MIP values (N=1500 rpm);

FIG. 6 illustrates an example of correlation between the MIP and an attribute of the graphic signature; and

FIG. 7 shows an on-line estimation of the MIP using attributes extracted from the signatures of FIG. 5.

### DETAILED DESCRIPTION OF THE INVENTION

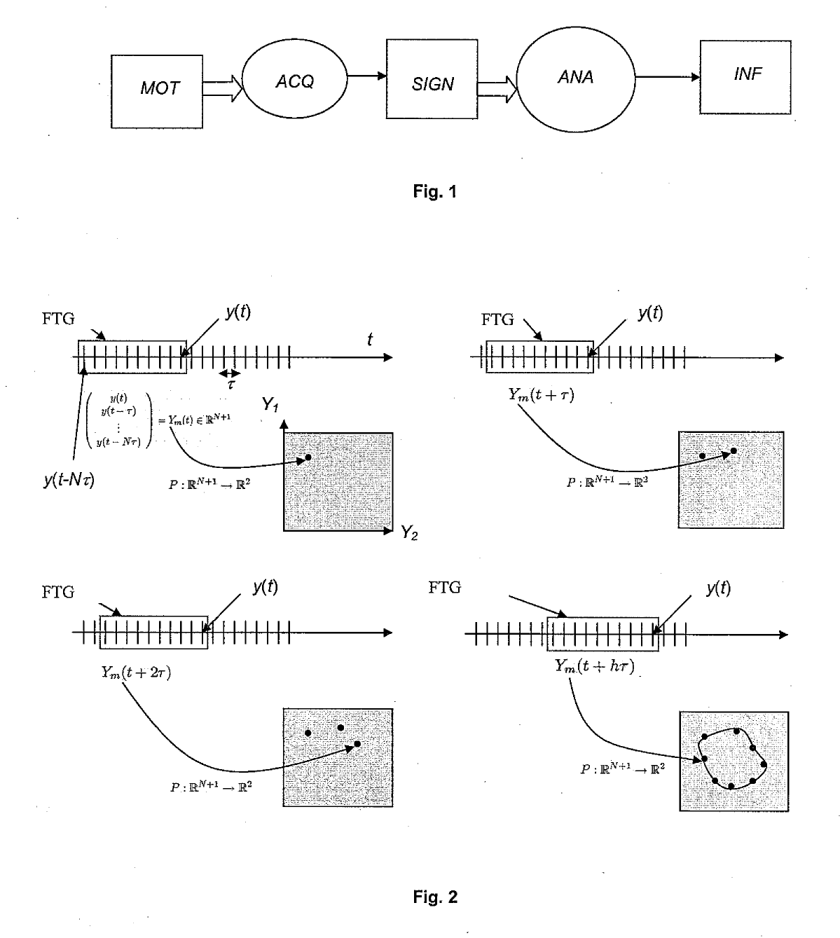

FIG. 1 describes the method of extracting engine information from measurements obtained from detectors. The method comprises four steps:

1—Acquisition of signals from detectors (ACQ)
2—Construction of a graphic signature (SIGN)
3—Determination of correlated attributes by graphic signature analysis (ANA)
4—Information extraction (INF).

1—Acquisition of Signals from Detectors (ACQ)

An internal-combustion engine (MOT) is equipped with various detectors. These detectors can be, for example, pressure detectors arranged within the cylinders, instantaneous engine speed detectors positioned on the engine shaft or rail pressure detectors for an engine equipped with a common rail.

High frequency signals are preferably measured (every 6 crank degrees, 1 crank degree, . . . ).

These signals contain information relative to the engine operation, among other pieces of information referred to as “parasitic”. It can be information concerning an event such as the occurrence of an injection. It can also be information about knowledge of an engine parameter, such as the torque. The goal is then to extract this information. Graphic signatures are therefore used.

2—Construction of a Graphic Signature (SIGN)

What is referred to as signature is a set of characteristic and recognizable features allowing one thing to be assigned to another. Within the scope of our invention, it is a set of characteristic and recognizable features allowing something to be assigned to a particular event linked with the operation of an internal-combustion engine.

According to the invention, a graphic signature is constructed. It is a signature whose characteristic and recognizable features are represented in form of a graph.

This graph has a set of points discretely forming a geometric shape. An example is given in FIG. 4, where a continuous line is added between the points for display reasons.

These signatures are obtained by use of a function allowing a signal to be converted into a graphic signature. Techniques for doing so are known.

According to a preferred embodiment, the signatures are obtained with a function allowing projection of the measurements obtained on line (in real time) and contained in a sliding time window, from a multidimensional space to a space of smaller dimension (for example, 2D (two dimension) plane. This dimension reduction provides easier analysis of the signal.

FIG. 2 illustrates the method of constructing a 2D graphic signature. A signature is associated with an engine cycle and with at least one signal (y). The following steps are carried out for each cycle to construct such a graphic signature:

At each time t, a vector Yₘ(t) having the present measurement y(t) and of the N past measurements is constructed:

$${Y}_{m} ( t ) = ( \begin{matrix}y ( t ) \\ y ( t - τ ) \\ ⋮ \\ y ( t - N τ )\end{matrix} ) ∈ {ℝ}^{N + 1}$$

What is referred to as vector is a quantity described by an n-dimensional space, by n scalar quantities arranged in a given order. It therefore is here a (N+1)-uplet.

Integer N is referred to as “signature order”. The sliding time window (FTG) is defined by time interval (t−N.τ; t). Parameter τ represents the time interval between two measurements of signal y.

Vector Yₘ(t) is then converted to a pair (y₁, y₂) representing a point in a 2D plane (Y₁; Y₂) referred to as the plane of the signature. This conversion is carried out by an application P: [symbol] → [symbol] .
Thus, as shown in FIG. 2, when time progresses, successive vectors Yₘ(t), Yₘ(+τ), . . . , Yₘ(t+4τ), . . . are obtained. Application P associates with each one of them a point in the plane of the signature. A two-dimensional graphic signature is thus obtained.

Definition of Application P

It can be reminded that, at any time t, the measurements contained in a sliding time window (FTG) are used to constitute the following measurement vector:

$${Y}_{m} ( t ) = ( \begin{matrix}y ( t ) \\ Y ( t )\end{matrix} ) ∈ {ℝ}^{N + 1} ;$$

$$Y ( t ) = ( \begin{matrix}y ( t - τ ) \\ ⋮ \\ y ( t - N τ )\end{matrix} ) ∈ {ℝ}^{N}$$

In order to associate a point in the signature plane with each vector Yₘ(t), the following steps are carried out:

a) The past measurement vector Y(t) is first normalized so as to obtain the following normalized vector Y̅(t):

$$\overline{Y} ( t ) = \frac{Y ( t )}{{‖ Y ‖}_{∞} + ɛ} ∈ {[ - 1 , 1 ]}^{N} ; {‖ Y ‖}_{∞} = {max}_{i ∈ \{ 1 , … N , \}} \vert {Y}_{i} \vert$$

where ε is a fixed regularization constant.

b) An application associating with each point of hypercube [−1,+1]^{N} is then defined as follows:

$$Ψ : {[ - 1 \; 1 ]}^{N} -> {ℝ}^{2} \times … \times {ℝ}^{2} = {( {ℝ}^{2} )}^{N}$$

$$Ψ ( \overline{Y} ) = ( {Ψ}_{1} ( \overline{Y} ) , … , {Ψ}_{N} ( \overline{Y} ) ) ; {Ψ}_{i} ( \overline{Y} ) ∈ {ℝ}^{2}$$

$$with \text{:}$$

$${Ψ}_{i} ( \overline{Y} ) = \frac{1}{2} [ ( 1 + {\overline{Y}}_{i} ) {S}_{( i + 1 \vert N )} - ( {\overline{Y}}_{i} - 1 ) {S}_{i} ]$$

$$where \text{:}$$

$$( i + 1 \vert N ) = ( i + 1 ) Modulo N$$

$${S}_{j} \text{:} image ( {e}^{2 j ( i - 1 ) \frac{π}{N}} ) ; {j}^{2} = - 1$$

where “image” designates the image point of this complex number, that is the point corresponding thereto in the 2D plane.

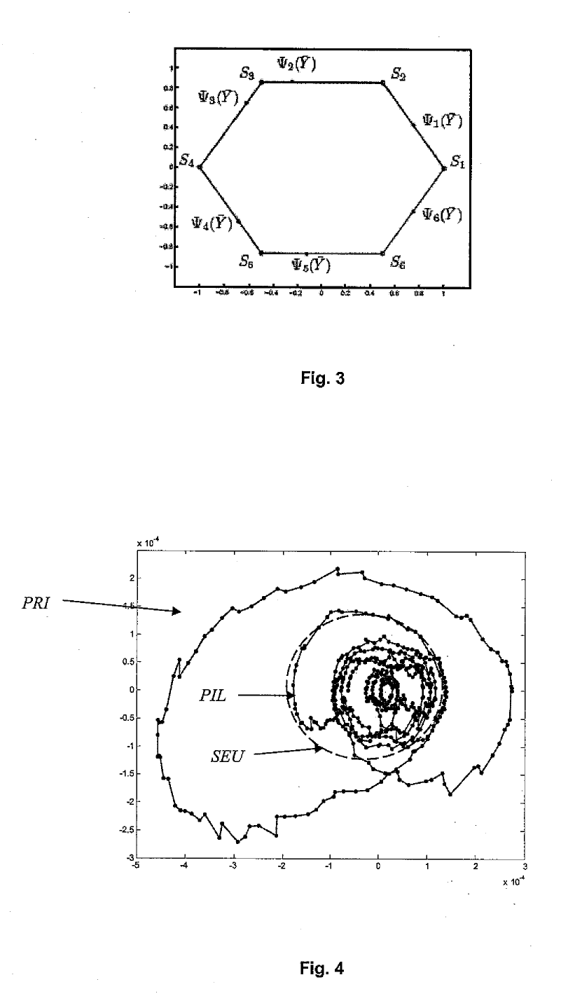

FIG. 3 shows an example of the positions of points Ψᵢ( Y̅) in the particular case where the normalized vector is given by:

N=6,Y=(0,0.5,−0.5,0.25,−0.25,0)^{T}.

c) The intermediate points Ψ₁( Y̅) are then used to calculate the following two points in the signature plane:

$${Φ}_{0} ( \overline{Y} ) = \frac{1}{N} {\sum }_{j = 1}^{N} {Ψ}_{j} ( \overline{Y} )$$

$${Φ}_{1} ( \overline{Y} ) = \frac{1}{N} {\sum }_{i = 1}^{N} {\overline{Y}}_{j} {Ψ}_{j} ( \overline{Y} )$$

These are the centers of mass (respectively weighted or not) of the previously calculated intermediate points. Application P is then given by:

$$P \text{:} {ℝ}^{N} \times ℝ {ℝ}^{2} ( \overline{Y} , y ) {Φ}_{0} ( \overline{Y} ) + [ \begin{matrix}\frac{y}{{‖ \overline{Y} ‖}_{∞} + ɛ} - \\ \frac{1}{N} {\sum }_{i = 1}^{N} {\overline{Y}}_{i}\end{matrix} ] [ {Φ}_{1} ( \overline{Y} ) - {Φ}_{0} ( \overline{Y} ) ]$$

It can be noted that vector ( Y̅,y) is obtained from measurement vector Yₘ with application of the normalization procedure to the latter N components.

This entirely defines the application allowing association with each measurement vector Yₘ(t) (constructed at time t with the past measurements recorded in a sliding window) being a point of the signature plane.

### Example of Results

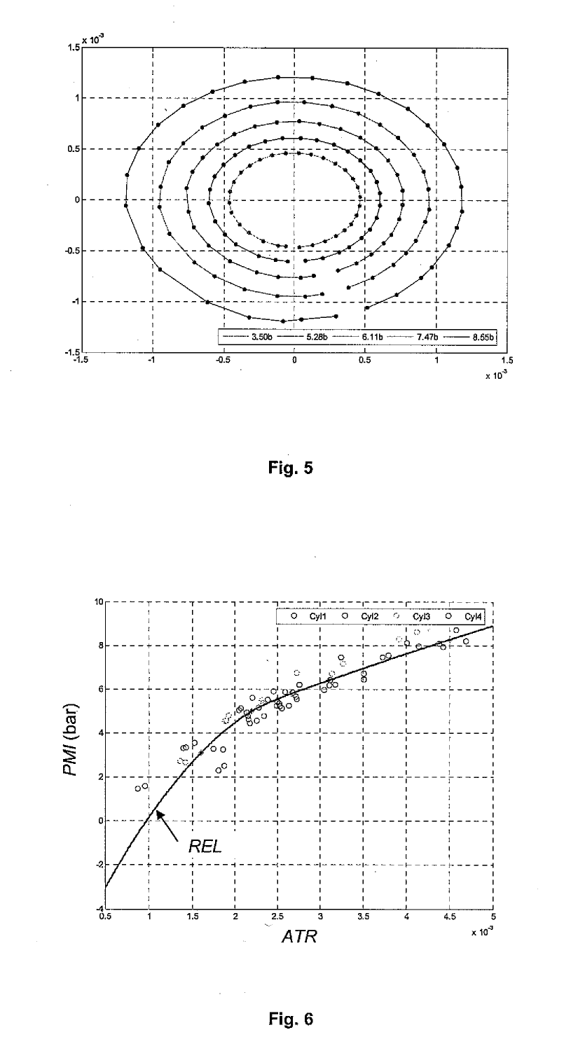

FIGS. 4 and 5 illustrate graphic signatures obtained from the method according to the invention.

FIG. 4 illustrates a signature obtained from real pressure measurements in the rail in the case of two injections.

FIG. 5 illustrates signatures obtained from real instantaneous engine speed measurements for different MIP values (N=1500 rpm).

3—Determination of Correlated Attributes by Graphic Signature Analysis (ANA)

A graphic signature is thus generated for each signal coming from a detector and for each cycle. A graphic signature then leads to a presentation of the information provided by the detector. This graphic signature represents a shape with points (one point for each signal measurement, in fact each point corresponds to a set of N+1 measurements). This shape has many attributes.

Attributes correlated with information related to the engine operation (event, engine parameter) are then sought among the attributes characterizing the graphic signature. An engine test bench on which various tests are carried out is therefore used:

a graphic signature is constructed for different values of the information;
attributes that evolve according to the value of the information are determined.

If the shape obtained from the graphic signature has precise geometric characteristics, if it is a circle for example, attributes can then be directly calculated: diameter, surface area, perimeter, . . . , or combinations of several attributes can be calculated. These attributes are preferably calculated using only the points that make up the signature, and not from the curve connecting the points.

### Examples are Given Hereafter

4—Extraction of Information Useful for Engine Control (INF)

These correlated attributes allow detection of events, such as injection, or to estimate parameters such as the MIP.

This step exploits the attributes of graphic signatures so as to provide useful information for engine control.

The Information can be Extracted:

either directly, that is directly from the value of the attribute, depending on its value, or by comparing the value of the attribute with a predetermined threshold;
or indirectly, by defining beforehand a relation allowing the information to be estimated from the value of the attribute.

The following steps can be carried out on an engine test bench in order to determine a relation between an attribute and a value of information:

constructing a graphic signature for different information values;
calculating the attribute for each signature; and
deducing the relation by comparing the attribute/information pairs for each signature.

The method is readily implemented in the conventional structure of engine control and it can be carried out in real time.

### Applications of the Information Extraction Method

I—Detection of Pilot Injections from Pressure Measurements in the Rail

The common rail injection system is a high-pressure injection system allowing producing the required amount of fuel according to various injection strategies (multi-injection). A short pilot injection precedes the main injection. This pilot injection is used to reduce combustion noises, notably under cold start conditions. Due to its short duration, the pilot injection is not always achieved. Under certain conditions, the injection nozzle is controlled but no amount of fuel is injected. This absence of injection has an influence on engine control.

Detection of the pilot injection therefore allows the engine performances to be improved.

In this context, the graphic signatures generated from the pressure measurements in the rail are used to detect the presence or the absence of pilot injections.

FIG. 4 illustrates an example of graphic signatures obtained according to the invention, from pressure measurements in the rail. Various sets of points forming each a relatively circular shape can be observed. It can be seen on the engine test bench that the main injection (PRI) corresponds to the largest circle. The pilot injection (PIL) takes place when the circle is larger than the circle in dotted line (SEU). This circle (SEU) is a threshold. It is defined on the engine bench, then it is implemented to constitute a detection of the pilot injection in comparison with the graphic signatures.

Specifically, while the engine is running, a signature is calculated at each cycle and compared with the threshold (that can be expressed analytically). It is for example possible to consider that the pilot injection takes place when the surface area of the graphic signature is greater than that of the threshold.

II—Estimation of the Engine Torque from Instantaneous Engine Speed Measurements

Knowledge of the torque provided by the combustion within each cylinder is a key element for engine control. However, for cost and feasibility reasons, current vehicles are not equipped with a detector suited for such a direct measurement. On the other hand, the instantaneous engine speed, providing information on the engine torque, can be measured.

The available instantaneous engine speed measurements are used to deduce the corresponding torque. Several methods are known from the literature for estimating the engine torque from the instantaneous engine speed. For example, it is possible to use the method of deconvolution in the frequency domain, or methods based on observers.

According to the invention, the graphic signatures are used as the basis in order to obtain quantitative information on the torque provided by each cylinder. Since the signature is generated from instantaneous engine speed measurements, containing information on the torque, it will be sensitive thereto.

Therefore, a correlation is sought between the signature obtained and the value of the torque in order to extract from the signature useful attributes for torque estimation.

FIG. 5 illustrates signatures obtained from real instantaneous engine speed measurements for different values of the mean indicated pressure (MIP). The signature allows obtaining quantitative information on the MIP and, consequently, on the torque provided by each cylinder from the instantaneous engine speed. In fact, the torque and the MIP are connected by the following relation:

$$P M I = π \cdot \frac{C}{{V}_{cyl}}$$

where the MIP PMI is expressed in bar, the torque C in N.m and the cylinder volume V_{cyl} in liter.

It can be seen that the size of the ellipsoids formed by the points of the various signatures is correlated with the MIP. In fact, the more the MIP increases, the larger the ellipsoid.

The following signature attribute ATR is then defined: horizontal diameter+vertical diameter. This attribute is calculated by summing the difference of the abscissas of the two points at the horizontal ends, with the difference of the ordinates of the two points at the vertical ends of the signature:

Horizontal diameter=max(xi)−min(xi)

Vertical diameter=max(yi)−min(yi)

ATR=max(xi) min(xi)+max(yi)−min(yi)

FIG. 6 shows the correlation between the MIP and attribute ATR of the graphic signature. The continuous line (REL) is an estimation of a relation between the MIP and attribute ATR extracted from the signature of FIG. 5.

Thus, within the context of engine control for a running vehicle, the graphic signature is calculated from real instantaneous engine speed measurements, then attribute ATR is calculated and the relation REL is applied to estimate the MIP.

The method based on graphic signatures can be readily applied in real time insofar as the signature calculating cost is low (simple arithmetic operations) in relation to complex optimization or filtering algorithms.

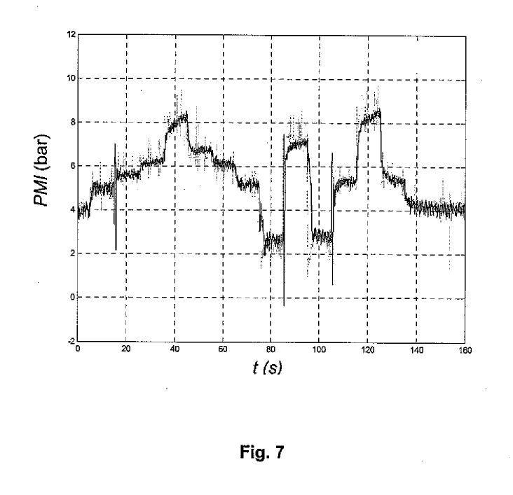

FIG. 7 shows a result of an on-line MIP estimation obtained using attributes extracted from a signature of FIG. 5 in real time. The light curve shows the real value of the MIP and the dark curve shows the estimation.

1-12. (canceled)

13. A method for controlling an internal-combustion engine including at least one detector, from which at least one signal is acquired containing at least information relative to operation of the engine including a set of discrete measurements, comprising:
selecting a function for converting the at least one signal into a graphic signature, by projection of signal measurements contained in a moving time window, from a multidimensional space to a space of fewer dimensions than the multidimensioned space; and
for each cycle of the engine converting the signal into the graphic signature with the function extracting the information from the signature and using the information to control the engine.

14. A method as claimed in claim 1, wherein the information is extracted by steps comprising:
selecting at least one attribute of the signature;
determining a relation between the attribute and the information and for each engine cycle calculating a value of the attribute for the signature; and
extracting the information by use of the value and the relation.

15. A method as claimed in claim 13, wherein the fewer dimensions than the multidimensions has two dimensions.

16. A method as claimed in claim 13, wherein the graphic signature is obtained at any time t by steps comprising:
constructing a vector including a measurement at time t and of measurements preceding time t; and
converting the vector into a pair of coordinates representing a point in a two dimension plane.

17. A method as claimed in claim 14, wherein the graphic signature is obtained at any time t by steps comprising:
constructing a vector including a measurement at time t and of measurements preceding time t; and
converting the vector into a pair of coordinates representing a point in a two dimension plane.

18. A method as claimed in claim 15, wherein the graphic signature is obtained at any time t by steps comprising:
constructing a vector including a measurement at time t and of measurements preceding time t; and
converting the vector into a pair of coordinates representing a point in a two dimension plane.

19. A method as claimed in claim 14, wherein the relation between the attribute and the information is determined by steps on an engine test bench comprising:
constructing a graphic signature for different information values;
calculating the attribute for each signature; and
determining the relation by comparing the attribute and information pairs for each signature.

20. A method as claimed in claim 15, wherein the relation between the attribute and the information is determined by steps on an engine test bench comprising:
constructing a graphic signature for different information values;
calculating the attribute for each signature; and
determining the relation by comparing the attribute and information pairs for each signature.

21. A method as claimed in claim 16, wherein the relation between the attribute and the information is determined by steps on an engine test bench comprising:
constructing a graphic signature for different information values;
calculating the attribute for each signature; and
determining the relation by comparing the attribute and information pairs for each signature.

22. A method as claimed in claim 17, wherein the relation between the attribute and the information is determined by steps on an engine test bench comprising:
constructing a graphic signature for different information values;
calculating the attribute for each signature; and
determining the relation by comparing the attribute and information pairs for each signature.

23. A method as claimed in claim 18, wherein the relation between the attribute and the information is determined by steps on an engine test bench comprising:
constructing a graphic signature for different information values;
calculating the attribute for each signature; and
determining the relation by comparing the attribute and information pairs for each signature.

24. A method as claimed in claim 13, wherein the signal is a pressure measurement from a common rail of the engine.

25. A method as claimed in claim 14, wherein the signal is a pressure measurement from a common rail of the engine.

26. A method as claimed in claim 15, wherein the signal is a pressure measurement from a common rail of the engine.

27. A method as claimed in claim 16, wherein the signal is a pressure measurement from a common rail of the engine.

28. A method as claimed in claim 19, wherein the signal is a pressure measurement in a common rail of the engine.

29. A method as claimed in claim 24, wherein the information corresponds to detection of an injection.

30. A method as claimed in claim 29 wherein the attribute is a surface area of the signature.

31. A method as claimed in claim 30, wherein the injection is detected by comparing surface area of the signature with a predetermined threshold.

32. A method as claimed in claim 13, wherein the signal is an instantaneous engine speed measurement.

33. A method as claimed in claim 14, wherein the signal is an instantaneous engine speed measurement.

34. A method as claimed in claim 15, wherein the signal is an instantaneous engine speed measurement.

35. A method as claimed in claim 16, wherein the signal is an instantaneous engine speed measurement.

36. A method as claimed in claim 19, wherein the signal is an instantaneous engine speed measurement.

37. A method as claimed in claim 32, wherein the information is engine torque.

38. A method as claimed in claim 32, wherein the attribute depends on a horizontal diameter and a vertical diameter of the graphic signature.

39. A method as claimed in claim 37, wherein the attribute depends on a horizontal diameter and a vertical diameter of the graphic signature.
